(19) United States
(12) Patent Application Publication
(10) Pub. No.: US 2026/0221620 A1
(43) Pub. Date: Jul. 30, 2026

(54) BATTERY AND CONNECTION METHOD THEREOF

(71) Applicant: EVE ENERGY CO., LTD., Huizhou (CN)

(72) Inventors: Leixin DENG, Huizhou (CN); Guiyong YI, Huizhou (CN); Mi LIU, Huizhou (CN); Pengyuan SONG, Huizhou (CN)

(73) Assignee: EVE ENERGY CO., LTD., Huizhou (CN)

(21) Appl. No.: 19/570,081

(22) Filed: Mar. 17, 2026

Related U.S. Application Data
(63) Continuation of application No. PCT/CN2024/140558, filed on Dec. 19, 2024.

(30) Foreign Application Priority Data
Dec. 25, 2023 (CN) 202311798381.8
Dec. 25, 2023 (CN) 202323550637.1

(51) Int. Cl. H01M 50/538; H01M 50/528; H01M 50/533; H01M 50/536

(52) U.S. Cl. CPC H01M 50/538; H01M 50/528; H01M 50/533; H01M 50/536

(57) ABSTRACT

A battery and a connection method therefor are provided. The battery includes a jelly roll and a housing. A plurality of negative tabs are arranged at intervals at one end of the jelly roll. The plurality of negative tabs are bent and overlap one another to form a complete tab structure at the one end of the jelly roll. The jelly roll is disposed in the housing. The housing includes a bottom plate, and the plurality of negative tabs are electrically connected to the bottom plate.

### CROSS-REFERENCE TO RELATED APPLICATIONS

This application is a bypass continuation application of International Patent Application No. PCT/CN2024/140558, filed on Dec. 19, 2024, which claims priority to Chinese Patent Application Nos. 202311798381.8 and 202323550637.1, both filed on Dec. 25, 2023. The entire contents of each of the above-referenced applications are expressly incorporated herein by reference.

### TECHNICAL FIELD

The present disclosure relates to the field of battery technology, and in particular, to a battery and a connection method therefor.

### BACKGROUND

In a conventional full-tab cylindrical battery, the negative electrode of a jelly roll is typically welded to a busbar through negative tabs. The busbar is subsequently welded to a steel housing such that the steel housing serves as a negative electrode.

Using a busbar as a welding bridge between the negative tabs and the steel housing requires a two-step welding process. This increases welding costs and internal resistance. Increased internal resistance reduces the current-carrying area of the full-tab cylindrical battery, resulting in a failure to meet high-current charge and discharge requirements. Furthermore, the presence of the busbar limits the width of the active material area (coated region) on the positive and negative electrode sheets. This reduces the active material content on the electrode sheets, preventing an increase in the capacity of the full-tab cylindrical battery.

### SUMMARY

Embodiments of the present application provide a battery and a connection method therefor to increase the current-carrying area of the battery, meet high-current charge and discharge requirements, and enhance the capacity of the battery.

In one aspect, a battery is provided. The battery includes a jelly roll and a housing. A plurality of negative tabs are arranged at intervals at one end of the jelly roll. The plurality of negative tabs are bent and overlap one another. The jelly roll is disposed in the housing. The housing includes a bottom plate. The plurality of negative tabs are electrically connected to the bottom plate.

In another aspect, a connection method applied to the battery is provided. The connection method is configured to electrically connect the negative tabs of the jelly roll to the bottom plate of the housing. The connection method includes: bending the plurality of negative tabs separately and overlapping the plurality of negative tabs; and electrically connecting the plurality of negative tabs to the bottom plate such that the housing serves as a negative electrode.

During the electrical connection, in the jelly roll, a sum A1 of a thickness of a positive electrode sheet, thicknesses of separators, and a thickness of a negative electrode sheet, and a height A2 of each negative tab satisfy a first preset connection condition. A width A3 of each negative tab and the height A2 of each negative tab satisfy a second preset connection condition. A gap L1 between two adjacent negative tabs satisfies a third preset connection condition.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the disclosure.

FIG. 1 is a schematic structural diagram of an exemplary battery according to an embodiment of the present disclosure.

FIG. 2 is a schematic structural diagram of an exemplary wound negative electrode sheet according to an embodiment of the present disclosure.

FIG. 3 is a schematic structural diagram of an exemplary unwound negative electrode sheet according to an embodiment of the present disclosure.

FIG. 4 is a schematic structural diagram of an exemplary jelly roll according to an embodiment of the present disclosure.

FIG. 5 is a side view of an exemplary bottom plate according to an embodiment of the present disclosure.

FIG. 6 is a bottom view of an exemplary bottom plate according to an embodiment of the present disclosure.

FIG. 7 is a flowchart of an exemplary connection method according to an embodiment of the present disclosure.

### REFERENCE NUMERALS:

1, jelly roll; 11, negative tab; 12, negative electrode sheet; 13, positive electrode sheet; 14, upper separator; 15, lower separator; 2, housing; 21, bottom plate.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented.

### Embodiment One

This embodiment provides a battery with a larger current-carrying area configured to meet high-current charge and discharge requirements and increase the capacity of the battery. The battery may be a cylindrical battery with a steel housing. In other embodiments, a prismatic battery or any other irregularly shaped battery may be used, and the shape of the battery is not limited herein.

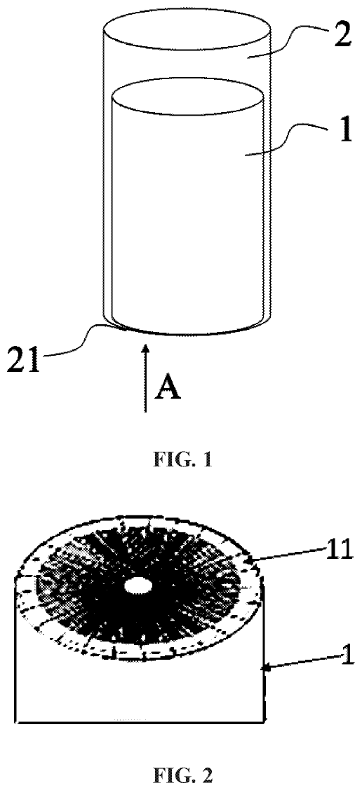

As shown in FIGS. 1 to 3, the battery includes a jelly roll 1 and a housing 2. A plurality of negative tabs 11 are arranged at intervals at one end of the jelly roll 1. The plurality of negative tabs 11 are arranged in a spiral structure on a negative end face of the jelly roll 1. The negative tabs 11 are bent and attached to the negative end face of the jelly roll 1.

In two adjacent arc-shaped rings of the formed spiral structure, the negative tabs 11 overlap one another so that the negative tabs 11 are electrically connected to each other to form a complete tab structure on the negative end face of the jelly roll 1. This enhances battery power and facilitates the subsequent electrical connection between the negative tabs 11 and the housing 2. The jelly roll 1 is disposed in the housing 2. The housing 2 includes a bottom plate 21. The plurality of negative tabs 11 are electrically connected to the bottom plate 21. In this embodiment, the housing 2 is a cylindrical steel housing, and the electrical connection direction between the negative tabs 11 and the bottom plate 21 is indicated by arrow A in FIG. 1.

In the embodiment, the negative tabs 11 are electrically connected to the bottom plate 21 by welding. In other embodiments, the negative tabs 11 may be electrically connected to the bottom plate 21 by rivets, screws, or conductive adhesives. The method of electrical connection is not limited herein.

In the battery of the present embodiment, the busbar is eliminated compared to the related art. The negative tabs 11 are welded directly to the bottom plate 21 of the housing 2 such that the housing 2 serves as the negative electrode. By eliminating the welding of the busbar, the number of welding operations is reduced to one. Compared with the two-step welding process in the related art, this reduces welding costs, increases the welding area between the negative tabs 11 and the bottom plate 21, and reduces the internal resistance associated with the extra welding step and the busbar itself. This results in a lower overall internal resistance of the battery, increasing the current-carrying area and meeting high-current charge and discharge requirements.

Moreover, the elimination of the busbar from the housing 2 increases the available space between the negative tabs 11 and the bottom plate 21. This allows for wider active material areas (coated regions) on the positive electrode sheet 13 and the negative electrode sheet 12. This increases the content of active material on the positive electrode sheet 13 and the negative electrode sheet 12, thereby enhancing the capacity of the battery. The capacity of the battery is a key performance indicator evaluating battery performance, representing the amount of electricity released by the battery under certain conditions such as discharge rate, temperature, and cut-off voltage.

In this embodiment, the battery requires only a single welding operation to weld the negative tabs 11 to the housing 2. Compared with the two-step welding process in the related art, the welding yield between the negative tabs 11 and the housing 2 in this embodiment is higher, thereby ensuring the welding effectiveness.

In this embodiment, because the width of the active material area on the positive electrode sheet 13 and the negative electrode sheet 12 is increased, the content of active material is increased, and the capacity of the battery is increased by 0.2%-0.6%. In addition, elimination of the busbar reduces one welding operation; thus, the internal resistance of the welding is reduced by 3%-10% and the internal resistance of the busbar is reduced by 0.1%-0.9%. Therefore, both the capacity and internal resistance of the battery are improved. The “width of the active material area” of the positive electrode sheet 13 or the negative electrode sheet 12 refers to the dimension, in the axial direction of the housing 2, of the area on the electrode sheet where the active material is applied.

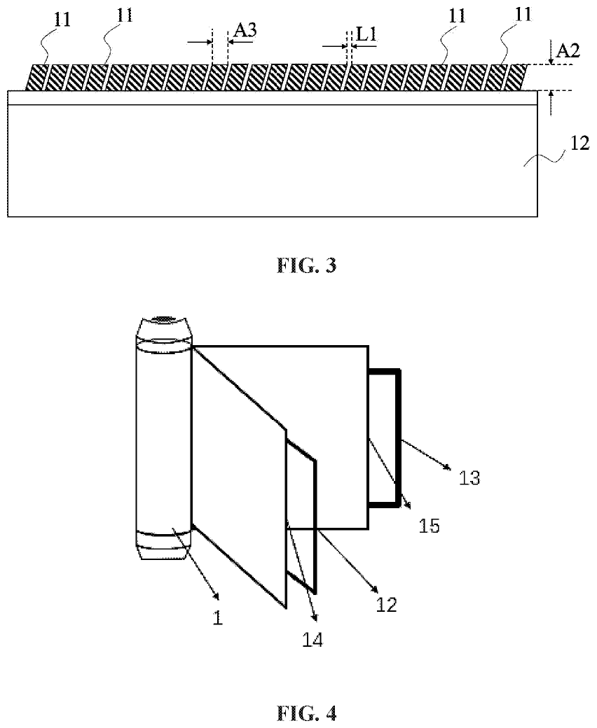

As shown in FIGS. 3 and 4, the jelly roll 1 includes a positive electrode sheet 13, separators (an upper separator 14 and a lower separator 15), and a negative electrode sheet 12 wound around each other. The negative tabs 11 are disposed at one end of the negative electrode sheet 12. A sum of the thickness of the positive electrode sheet 13, the thicknesses of the separators (the upper separator 14 and the lower separator 15), and the thickness of the negative electrode sheet 12 is defined as A1. The height of each negative tab 11 is defined as A2. A1 and A2 satisfy 0.05±0.01<A1/A2<0.1±0.01 to ensure the weldability between the negative tabs 11 and the bottom plate 21. The process of winding the positive electrode sheet 13, the separators (the upper separator 14 and the lower separator 15), and the negative electrode sheet 12 to form the jelly roll 1 is a common winding process in the related art and thus is not described in detail here. In the embodiment, A1 and A2 satisfy 0.05<A1/A2<0.1.

As shown in FIG. 3, the width of each negative tab 11 is A3. A2 and A3 satisfy 0.4±0.05<A3/A2<0.9±0.05 to ensure the weldability between the negative tabs 11 and the bottom plate 21. In the embodiment, A2 and A3 satisfy 0.4<A3/A2<0.9.

As shown in FIG. 3, the gap between two adjacent negative tabs 11 is defined as L1. L1 satisfies L1<0.2±0.05 mm to ensure the weldability between the negative tabs 11 and the bottom plate 21. In the embodiment, L1 satisfies L1<0.2 mm.

Therefore, the parameters of the positive electrode sheet 13, the separators (the upper separator 14 and the lower separator 15), the negative electrode sheet 12, and the negative tabs 11 of the jelly roll 1 are set such that 0.05±0.01<A1/A2<0.1±0.01, 0.4±0.05<A3/A2<0.9±0.05, and L1<0.2±0.05 mm. When the jelly roll 1 satisfies all the parameter settings, the weldability between the negative tabs 11 and the bottom plate 21 of the housing 2 can be ensured and the negative tabs 11 can be welded to the bottom plate 21.

The negative tabs 11 are welded to the bottom plate 21 by laser deep penetration welding. On one hand, such welding allows for a relatively deep welding depth in the welding area between the negative tabs 11 and the bottom plate 21, ensuring the welding stability between the negative tabs 11 and the bottom plate 21. On the other hand, such welding results in a smaller welding area, leaving sufficient space on the bottom plate 21 of the housing 2 for welding of other components.

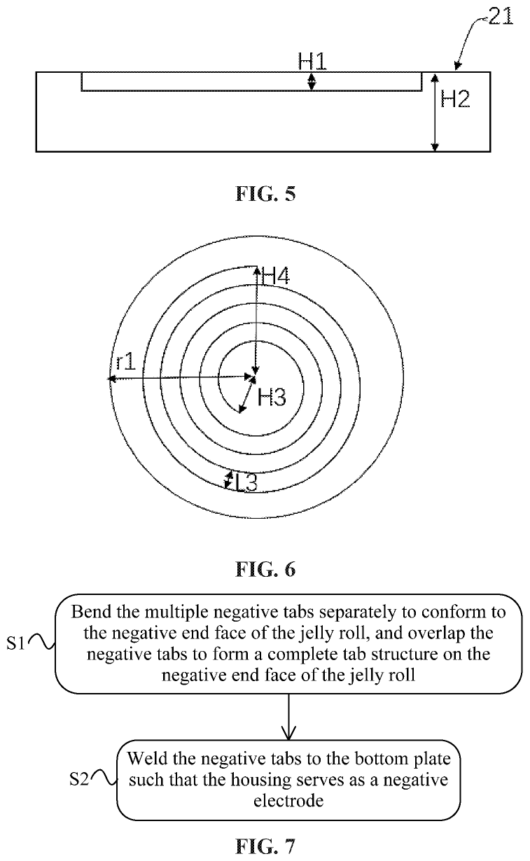

As shown in FIGS. 5 and 6, the welding area of the bottom plate 21 for the negative tabs 11 is arranged in a spiral line that matches the spiral structure of the overlapped tabs. This ensures that most of the negative tabs 11 are welded to the bottom plate 21 and ensures stability of the welding between the bottom plate 21 and the negative tabs 11.

The welding depth of the welding area is defined as H1. The thickness of the bottom plate 21 is H2. H1 and H2 satisfy 0.2±0.05<H1/H2<0.6±0.05. This setting of the welding depth H1 and the thickness of the bottom plate 21 ensures that the welding between the negative tabs 11 and the bottom plate 21 is more stable and secure. Moreover, this setting can also reduce the internal resistance of the spiral line and decrease heat generation, thereby increasing the current-carrying area of the battery. In the embodiment, H1 and H2 satisfy 0.2<H1/H2<0.6.

A distance from a start point of the spiral line to a center of the jelly roll 1 is defined as H3. A radius of the bottom plate 21 is defined as r1. H3 and r1 satisfy H3>r1×0.2. a distance from an end point of the spiral line to the center of the jelly roll 1 is defined as H4. H4 and r1 satisfy H4<r1×0.85. This setting ensures that most of the negative tabs 11 can be welded to the bottom plate 21 and ensures stability of the welding between the bottom plate 21 and the negative tabs 11.

The length of the spiral line is defined as L2. The radius of the jelly roll 1 is defined as r2. L2 and r2 satisfy L2>r2×15.71. This ensures the spiral line is not too short so that most of the negative tabs 11 can be welded to the bottom plate 21. At the same time, this prevents excessive internal resistance and high welding costs caused by an overly long spiral line.

The pitch of the spiral line is defined as L3. L3 satisfies 0.1±0.01 mm<L3<0.5±0.01 mm. This pitch is appropriate under a fixed length of the spiral line, and ensures the welding uniformity between the bottom plate 21 and the negative tabs 11, enabling the bottom plate 21 to be uniformly welded to most of the negative tabs 11, and avoiding welding that is either too dense or too sparse. The pitch of the spiral line refers to the distance between two adjacent turns of the spiral. In the embodiment, L3 satisfies 0.1 mm<L3<0.5 mm.

In the battery of the embodiment, the busbar is eliminated and the negative tabs 11 is welded to the bottom plate 21 of the housing 2 directly. This design increases the capacity of the battery and the current-carrying area and enables the battery to meet the high-current charge and discharge requirements. In addition, the parameters of the positive electrode sheet 13, the separators (the upper separator 14 and the lower separator 15), the negative electrode sheet 12, and the negative tabs 11 of the jelly roll 1 are set to ensure the weldability between the tabs of the jelly roll 1 and the bottom plate 21. Moreover, the welding parameters of the welding method, the welding depth, the welding area, and the spiral line are set to ensure the welding stability between the negative tabs 11 and the bottom plate 21 and prevent the negative tabs 11 from detaching from the bottom plate 21.

In summary, in the battery of the embodiment, the jelly roll 1 needs to satisfy the following three conditions: 0.05±0.01<A1/A2<0.1±0.01, 0.4±0.05<A3/A2<0.9±0.05, and L1<0.2±0.05 mm, thereby ensuring the weldability between the negative tabs 11 of the formed jelly roll 1 and the bottom plate 21 of the housing 2. Moreover, the welding parameters are required to satisfy any one or more of the following six conditions: laser deep penetration welding is performed, 0.2±0.05<H1/H2<0.6±0.05, the welding area is set as a spiral line matching the spiral structure, H3>r1×0.2 and H4<r1×0.85, L2>r2×15.71, and 0.1±0.01 mm<L3<0.5±0.01 mm. This ensures the welding stability between the negative tabs 11 and the bottom plate 21, prevents the negative tabs 11 from detaching from the bottom plate 21, and enhances the overall performance of the battery.

### Embodiment Two

In this embodiment, a connection method is provided based on the battery of Embodiment One. The connection method is configured to weld the negative tabs 11 of the battery to the bottom plate 21 of the housing 2. As shown in FIG. 7, the connection method includes the following steps:
In S1, the plurality of negative tabs 11 arranged in the spiral structure are bent separately to conform to the negative end face of the jelly roll 1, wherein in the spiral structure, adjacent turns of negative tabs 11 overlap each other to form a complete tab structure on the negative end face of the jelly roll 1.
In S2, the negative tabs 11 are welded to the bottom plate 21 such that the housing 2 serves as a negative electrode.

During the welding, the sum A1 of the thickness of the positive electrode sheet 13, the thicknesses of the separators (separator 14 and separator 15), and the thickness of the negative electrode sheet 12, and the height A2 of each negative tab 11 satisfy a first preset connection condition. The width A3 of each negative tab 11 and the height A2 of each negative tab 11 satisfy a second preset connection condition. A gap L1 between two adjacent negative tabs 11 satisfies a third preset connection condition. Thus, the weldability between the negative tabs 11 and the bottom plate 21 can be ensured.

The first preset connection condition is 0.05±0.01<A1/A2<0.1±0.01 as described in embodiment one, the second preset connection condition is 0.4±0.05<A3/A2<0.9±0.05 as described in embodiment one, and the third preset connection condition is L1<0.2±0.05 mm as described in embodiment one so that a jelly roll 1 satisfying the connection conditions can be formed, thereby enabling the negative tabs 11 of the jelly roll 1 to be welded to the bottom plate 21.

The connection method of this embodiment enables the negative tabs 11 to be directly welded to the bottom plate 21 of the housing 2 in a single welding process, resulting in fewer welding operations and lower welding costs. Moreover, since only one welding process is performed, a high welding yield between the negative tabs 11 and the bottom plate 21 can be ensured. In addition, the settings of the first preset connection condition, the second preset connection condition, and the third preset connection condition can ensure the weldability between the negative tabs 11 of the jelly roll 1 and the bottom plate 21.

What is claimed is:

1. A battery, comprising:
a jelly roll, wherein a plurality of negative tabs are arranged at intervals at one end of the jelly roll, and the plurality of negative tabs are bent and overlap one another; and
a housing, wherein the jelly roll is disposed in the housing, the housing comprises a bottom plate, and the plurality of negative tabs are electrically connected to the bottom plate.

2. The battery of claim 1, wherein the jelly roll comprises a positive electrode sheet, separators, and a negative electrode sheet wound around each other, and the plurality of negative tabs are arranged at one end of the negative electrode sheet,
wherein a sum of a thickness of the positive electrode sheet, a thickness of the separators, and a thickness of the negative electrode sheet is A1, a height of each of the plurality of negative tabs is A2, and 0.05±0.01<A1/A2<0.1±0.01.

3. The battery of claim 2, wherein a width of each of the plurality of negative tabs is A3, and 0.4±0.05<A3/A2<0.9±0.05.

4. The battery of claim 1, wherein a gap between two adjacent negative tabs of the plurality of negative tabs is L1, and L1<0.2±0.05 mm.

5. The battery of claim 2, wherein a gap between two adjacent negative tabs of the plurality of negative tabs is L1, and L1<0.2±0.05 mm.

6. The battery of claim 3, wherein a gap between two adjacent negative tabs of the plurality of negative tabs is L1, and L1<0.2±0.05 mm.

7. The battery of claim 1, wherein the plurality of negative tabs are electrically connected to the bottom plate by laser deep penetration welding.

8. The battery of claim 3, wherein the plurality of negative tabs are electrically connected to the bottom plate by laser deep penetration welding.

9. The battery of claim 6, wherein the plurality of negative tabs are electrically connected to the bottom plate by laser deep penetration welding.

10. The battery of claim 1, wherein an electrical connection area between the plurality of negative tabs and the bottom plate is configured as a spiral line, an electrical connection depth of the electrical connection area is H1, a thickness of the bottom plate is H2, and 0.2±0.05<H1/H2<0.6±0.05.

11. The battery of claim 2, wherein an electrical connection area between the plurality of negative tabs and the bottom plate is configured as a spiral line, an electrical connection depth of the electrical connection area is H1, a thickness of the bottom plate is H2, and 0.2±0.05<H1/H2<0.6±0.05.

12. The battery of claim 3, wherein an electrical connection area between the plurality of negative tabs and the bottom plate is configured as a spiral line, an electrical connection depth of the electrical connection area is H1, a thickness of the bottom plate is H2, and 0.2±0.05<H1/H2<0.6±0.05.

13. The battery of claim 9, wherein an electrical connection area between the plurality of negative tabs and the bottom plate is configured as a spiral line, an electrical connection depth of the electrical connection area is H1, a thickness of the bottom plate is H2, and 0.2±0.05<H1/H2<0.6±0.05.

14. The battery of claim 10, wherein a distance from a start point of the spiral line to a center of the jelly roll is H3, a radius of the bottom plate is r1, and H3>r1×0.2,
wherein a distance from an end point of the spiral line to the center of the jelly roll is H4, and H4<r1×0.85.

15. The battery of claim 14, wherein a length of the spiral line is L2, a radius of the jelly roll is r2, and L2>r2×15.71.

16. The battery of claim 15, wherein a pitch of the spiral line is L3, and 0.1±0.01 mm<L3<0.5±0.01 mm.

17. A connection method applied to a battery for electrically connecting a plurality of negative tabs of a jelly roll of the battery to a bottom plate of a housing of the battery, the connection method comprising:
bending the plurality of negative tabs separately and overlapping the plurality of negative tabs, wherein the plurality of negative tabs are arranged at intervals at one end of the jelly roll and the jelly roll is disposed in the housing; and
electrically connecting the plurality of negative tabs to the bottom plate such that the housing serves as a negative electrode.

18. The connection method of claim 17, wherein the jelly roll comprises a positive electrode sheet, separators, and a negative electrode sheet wound around each other, and the plurality of negative tabs are arranged at one end of the negative electrode sheet,
wherein a sum A1 of a thickness of the positive electrode sheet, a thickness of the separators, and a thickness of the negative electrode sheet and a height A2 of each of the plurality of negative tabs satisfy a first preset connection condition: 0.05±0.01<A1/A2<0.1±0.01.

19. The connection method of claim 17, further comprising:
making a width A3 of each of the plurality of negative tabs and the height A2 satisfy a second preset connection condition: 0.4±0.05<A3/A2<0.9±0.05.

20. The connection method of claim 17, further comprising:
making a gap L1 between two adjacent negative tabs of the plurality of negative tabs satisfy a third preset connection condition: L1<0.2±0.05 mm.
